(19) United States
(12) Patent Application Publication
(10) Pub. No.: US 2009/0115714 A1
(43) Pub. Date: May 7, 2009

(54) LIQUID CRYSTAL DISPLAY

(76) Inventors: Hee-Seong Jeong, Yongin-si (KR); Gun-Shik Kim, Yongin-si (KR); Jae-Kwang Ryu, Yongin-si (KR); Jun-Sik Oh, Yongin-si (KR); Jae-Woo Bae, Yongin-si (KR); Myun-Gi Shim, Yongin-si (KR); Do-Hyung Park, Yongin-si (KR); Kyu-Chan Park, Yongin-si (KR); Sang-Yeol Hur, Yongin-si (KR); Dong-Gun Moon, Yongin-si (KR)

Correspondence Address: CHRISTIE, PARKER & HALE, LLP, PO BOX 7068, PASADENA, CA, 91109-7068, US

(21) Appl. No.: 12/263,166

(22) Filed: Oct. 31, 2008

(30) Foreign Application Priority Data
Nov. 7, 2007 (KR) 10-2007-0113250

(51) Int. Cl. G09G 3/36

(52) U.S. Cl. 345/88

(57) ABSTRACT

A liquid crystal display (LCD) having color filters configured according to optical characteristics of a field emission backlight. The LCD includes: a display panel having color filters including red, green, and blue filters; and a backlight device at a rear side of the display panel and including a vacuum panel with a cold cathode electron source and a phosphor layer that is excited by electrons emitted from the cold cathode electron source to emit visible light. Here, a wavelength position corresponding to a half of a peak intensity of a transmission spectrum of the red filter is at from about 570 nm to about 622 nm, a wavelength position corresponding to a half of a peak intensity of a transmission spectrum of the blue filter is not greater than 520 nm, and/or a transmission spectrum of the green filter has a full width at half maximum (FWHM) ranging from about 60 nm to about 115 nm.

### CROSS-REFERENCE TO RELATED APPLICATION

This application claims priority to and the benefit of Korean Patent Application No. 10-2007-0113250, filed in the Korean Intellectual Property Office on Nov. 7, 2007, the entire content of which is incorporated herein by reference.

### BACKGROUND OF THE INVENTION

1. Field of the Invention

The present invention relates to a liquid crystal display (LCD) and, more particularly, to a backlight device providing white light to a display panel, and red, green, and blue color filters provided in the display panel.

2. Description of the Related Art

In general, an LCD includes a display panel and a backlight device disposed at a rear side of the display panel and providing white light to the display panel. In the display panel, by using the dielectric anisotropy characteristics of liquid crystals having a helix angle that varies according to a voltage applied thereto, an amount of light transmittance can be changed per sub-pixel such that white light can be changed to red, green, and blue light through color filters per sub-pixel in order to display certain color images.

As the backlight device, a cold cathode fluorescent lamp (CCFL) type of backlight can be used. The CCFL is a linear light source. The CCFL backlight can provide light generated from the CCFL by evenly distributing the light using optical members such as a light guide plate, a reflection plate, a diffusion sheet, and/or a prism sheet installed therein.

However, in the CCFL backlight, a considerable amount of light generated from the CCFL is lost while the light is passing through the optical members. Therefore, in order to compensate such light loss, the CCFL should emit light with high strength, but this increases power consumption. In addition, because the CCFL backlight cannot be enlarged in size, it is difficult to apply it to a large LCD of 30 inches or wider.

Thus, recently, a field emission type of backlight having a cold cathode electron source and a phosphor layer within a vacuum panel has been proposed. In the field emission backlight, electrons are emitted from the cold cathode electron source by using a field to excite the phosphor layer to emit visible light. Here, the field emission backlight has high luminance and low power consumption, and can be easily fabricated to be large in size.

Also, in the LCD, display characteristics such as a color reproduction rate, color purity, white color temperature, luminance, etc. are largely determined by an emission spectrum of the backlight and a transmission spectrum of color filters of the display panel. Namely, when the color filters have an appropriate transmission band and peak wavelength over the transmission spectrum of white light emitted from the backlight, optimum display characteristics can be obtained.

However, the characteristics of the color filters of the related art LCD have been adjusted (adapted) to the CCFL backlight, so in order to apply the field emission backlight, the color filter characteristics of the display panel need to be suitably controlled (or adjusted or configured) according to optical characteristics of the field emission backlight.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of an embodiment of the present invention is directed toward a liquid crystal display (LCD) employing a field emission type of backlight having suitably controlled (or adjusted or configured) characteristics of color filters of a display panel according to optical characteristics of the field emission type backlight.

An exemplary embodiment of the present invention provides an LCD including: a display panel having color filters including a red filter, a green filter, and a blue filter; and a backlight device positioned at a rear side of the display panel and including a vacuum panel provided with a cold cathode electron source and a phosphor layer that is excited by electrons emitted from the cold cathode electron source to emit visible light. Here, a wavelength position corresponding to a half of a peak intensity of a transmission spectrum of the red filter is at from about 570 nm to about 622 nm.

The phosphor layer may include red phosphor, green phosphor, and blue phosphor. The red phosphor may be selected from the group consisting of Y₂O₃:Eu, Y₂O₂S:Eu, SrTiO₃:Pr, and combinations thereof. The green phosphor may be selected from the group consisting of Y₂SiO₅:Tb, Gd₂O₂S:Tb, ZnS:(Cu, Al), ZnSiO₄:Mn, Zn(Ga, Al)₂O₄:Mn, and combinations thereof. The blue phosphor may be selected from the group consisting of ZnS:(Ag, Al), Y₂SiO₅:Ce, BaMgAl₁₀O₁₇:Eu, and combinations thereof.

In one embodiment, x and y color coordinates of white light emitted from the phosphor layer are 0.2622 and 0.3139, respectively. The white light emitted from the phosphor layer may exhibit a blue peak wavelength at about 450 nm, a green peak wavelength at about 530 nm, and a red peak wavelength at about 610 nm. The peak intensity ratio of blue light, green light, and red light of the white light emitted from the phosphor layer may be 1.5:1:2.

The display panel may include first pixels, and the backlight may include second pixels smaller in number than the first pixels. The second pixels may emit light in accordance with gray levels of a corresponding set of the first pixels.

Another exemplary embodiment of the present invention provides an LCD including: a display panel having color filters including a red filter, a green filter, and a blue filter; and a backlight device positioned at a rear side of the display panel and including a vacuum panel provided with a cold cathode electron source and a phosphor layer that is excited by electrons emitted from the cold cathode electron source to emit visible light. Here, a wavelength position corresponding to a half of a peak intensity of a transmission spectrum of the blue filter is not greater than 520 nm.

The phosphor layer may comprise red phosphor, green phosphor, and blue phosphor. The red phosphor may be selected from the group consisting of Y₂O₃:Eu, Y₂O₂S:Eu, SrTiO₃:Pr, and combinations thereof. The green phosphor may be selected from the group consisting of Y₂SiO₅:Tb, Gd₂O₂S:Tb, ZnS:(Cu, Al), ZnSiO₄:Mn, Zn(Ga, Al)₂O₄:Mn, and combinations thereof. The blue phosphor may be selected from the group consisting of ZnS:(Ag, Al), Y₂SiO₅:Ce, BaMgAl₁₀O₁₇:Eu, and combinations thereof.

In one embodiment, x and y color coordinates of white light emitted from the phosphor layer are 0.2622 and 0.3139, respectively. The white light emitted from the phosphor layer may exhibit a blue peak wavelength at about 450 nm, a green peak wavelength at about 530 nm, and a red peak wavelength at about 610 nm. The peak intensity ratio of blue light, green light, and red light of the white light emitted from the phosphor layer may be 1.5:1:2.

The display panel may include first pixels, and the backlight may include second pixels smaller in number than the first pixels. The second pixels may emit light in accordance with gray levels of a corresponding set of the first pixels.

Still another exemplary embodiment of the present invention provides an LCD including: a display panel having color filters including a red filter, a green filter, and a blue filter; and a backlight device positioned at a rear side of the display panel and including a vacuum panel provided with a cold cathode electron source and a phosphor layer that is excited by electrons emitted from the cold cathode electron source to emit visible light. Here, a transmission spectrum of the green filter has a full width at half maximum (FWHM) ranging from about 60 nm to about 115 nm.

The transmission spectrum of the green filter may have the FWHM of about 60 nm and a peak wavelength ranging from about 507 nm to about 556 nm. The transmission spectrum of the green filter may have the FWHM of about 80 nm and a peak wavelength ranging from about 512 nm to about 556 nm. The transmission spectrum of the green filter may have the FWHM of about 100 nm and a peak wavelength ranging from about 517 nm to about 553 nm. The transmission spectrum of the green filter may have the FWHM of about 115 nm and a peak wavelength ranging from about 535 nm to about 542 nm.

The phosphor layer may include red phosphor, green phosphor, and blue phosphor. The red phosphor may be selected from the group consisting of Y₂O₃:Eu, Y₂O₂S:Eu, SrTiO₃:Pr, and combinations thereof. The green phosphor may be selected from the group consisting of Y₂SiO₅:Tb, Gd₂O₂S:Tb, ZnS:(Cu, Al), ZnSiO₄:Mn, Zn(Ga, Al)₂O₄:Mn, and combinations thereof. The blue phosphor may be selected from the group consisting of ZnS:(Ag, Al), Y₂SiO₅:Ce, BaMgAl₁₀O₁₇:Eu, and combinations thereof.

In one embodiment, x and y color coordinates of white light emitted from the phosphor layer are 0.2622 and 0.3139, respectively. The white light emitted from the phosphor layer may exhibit a blue peak wavelength at about 450 nm, a green peak wavelength at about 530 nm, and a red peak wavelength at about 610 nm. The peak intensity ratio of blue light, green light, and red light of the white light emitted from the phosphor layer may be 1.5:1:2.

The display panel may include first pixels, and the backlight may include second pixels smaller in number than the first pixels. The second pixels may emit light in accordance with gray levels of a corresponding set of the first pixels.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective schematic of a liquid crystal display (LCD) according to an exemplary embodiment of the present invention.

FIG. 2 is a partially cut-away perspective schematic of a backlight device in FIG. 1.

FIG. 3 is a partial cross-sectional schematic of the backlight device in FIG. 1.

FIG. 4 is a partial cross-sectional schematic of a display panel in FIG. 1.

FIG. 5 is a graph showing a spectrum of white light emitted from the backlight device in FIG. 1.

FIG. 6 is a graph showing a transmission spectrum of a color filter including a red filter of which a wavelength position that corresponds to a half of a peak intensity is at about 570 nm (or at 570 nm), and emission spectrums of phosphors of the backlight device.

FIG. 7 is a graph showing emission spectrums of red, green, and blue light that has passed through color filters having transmission characteristics of FIG. 6.

FIG. 8 is a graph showing an emission spectrum of white light that has passed through the color filters having the transmission characteristics of FIG. 6.

FIG. 9 is a graph showing a transmission spectrum of a color filter including a red filter of which a wavelength position that corresponds to a half of a peak intensity is at about 622 nm (or is at 622 nm), and emission spectrums of phosphors of the backlight device.

FIG. 10 is a graph showing emission spectrums of red, green, and blue light that has passed through the color filters having the transmission characteristics of FIG. 9.

FIG. 11 is a graph showing an emission spectrum of white light that has passed through the color filters having the transmission characteristics of FIG. 9.

FIG. 12 is a graph showing a transmission spectrum of a color filter including a blue filter of which a wavelength position that corresponds to a half of a peak intensity is at about 520 nm (or is at 520 nm), and emission spectrums of phosphors of the backlight.

FIG. 13 is a graph showing emission spectrums of red, green, and blue light that has passed through the color filter having the transmission characteristics of FIG. 12.

FIG. 14 is a graph showing an emission spectrum of white light that has passed through the color filter having the transmission characteristics of FIG. 12.

FIG. 15 is a graph showing a transmission spectrum of a color filter including a green filter of which a full width at half maximum (FWHM) is about 60 nm (or at 60 nm) and a peak wavelength is about 556 nm, and emission spectrums of the phosphors of the backlight device.

FIG. 16 is a graph showing emission spectrums of red, green, and blue light that has passed through the color filters having the transmission characteristics of FIG. 15.

FIG. 17 is a graph showing a transmission spectrum of a color filter including a green filter having the FWHM of about 60 nm (or of 60 nm) and a peak wavelength of about 507 nm, and emission spectrums of the phosphor of the backlight.

FIG. 18 is a graph showing emission spectrums of red, green, and blue light that has passed through the color filters having the transmission characteristics of FIG. 17.

FIG. 19 is a graph showing a transmission spectrum of a color filter including a green filter having the FWHM of about 80 nm (or of 80 nm) and a peak wavelength of about 556 nm, and emission spectrums of the phosphors of the backlight device.

FIG. 20 is a graph showing emission spectrums of red, green, and blue light that has passed through the color filters having the transmission characteristics of FIG. 19.

FIG. 21 is a graph showing a transmission spectrum of a color filter including a green filter having the FWHM of about 80 nm (or of 80 nm) and a peak wavelength of about 512 nm, and emission spectrums of the phosphors of the backlight device.

FIG. 22 is a graph showing emission spectrums of red, green, and blue light that has passed through the color filters having the transmission characteristics of FIG. 21.

FIG. 23 is a graph showing a transmission spectrum of a color filter including a green filter having the FWHM of about 100 nm (or of 100 nm) and a peak wavelength of about 553 nm, and emission spectrums of the phosphors of the backlight device.

FIG. 24 is a graph showing emission spectrums of red, green, and blue light that has passed through the color filters having the transmission characteristics of FIG. 23.

FIG. 25 is a graph showing a transmission spectrum of a color filter including a green filter having the FWHM of about 100 nm (or of 100 nm) and a peak wavelength of about 517 nm, and emission spectrums of the phosphors of the backlight device.

FIG. 26 is a graph showing emission spectrums of red, green, and blue light that has passed through the color filters having the transmission characteristics of FIG. 25.

FIG. 27 is a graph showing a transmission spectrum of a color filter including a green filter having the FWHM of about 115 nm (or of 115 nm) and a peak wavelength of about 542 nm, and emission spectrums of the phosphors of the backlight device.

FIG. 28 is a graph showing emission spectrums of red, green, and blue light that has passed through the color filters having the transmission characteristics of FIG. 27.

FIG. 29 is a graph showing a transmission spectrum of a color filter including a green filter having the FWHM of about 115 nm (or of 115 nm) and a peak wavelength of about 535 nm, and emission spectrums of the phosphors of the backlight device.

FIG. 30 is a graph showing emission spectrums of red, green, and blue light that has passed through the color filters having the transmission characteristics of FIG. 29.

FIG. 31 is a graph showing results of luminance experimentation of an exemplary embodiment of the present invention in which the FWHM of the green filter was about 78 nm (or 78 nm) and a comparative example in which the FWHM of the green filter was about 58 nm (or 58 nm).

### DETAILED DESCRIPTION OF THE EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

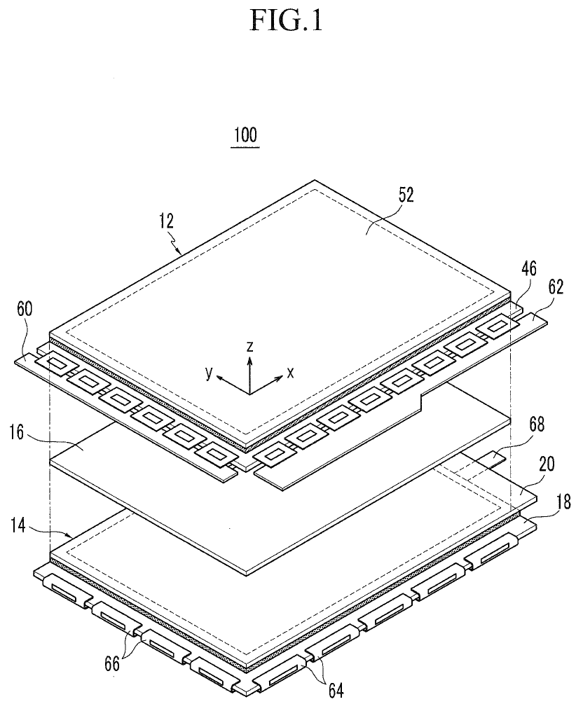

FIG. 1 is an exploded perspective schematic of a liquid crystal display (LCD) according to an exemplary embodiment of the present invention.

With reference to FIG. 1, the LCD includes a display panel 12, and a backlight device 14 positioned at a rear side of the display panel 12 and providing white light to the display panel 12. A light diffuser 16 that evenly diffuses light emitted from the backlight device 14 may be positioned between the display panel 12 and the backlight device 14.

The backlight device 14 is a field emission type of backlight composed of a cold cathode electron source and a phosphor layer that are within a vacuum panel (or vacuum vessel).

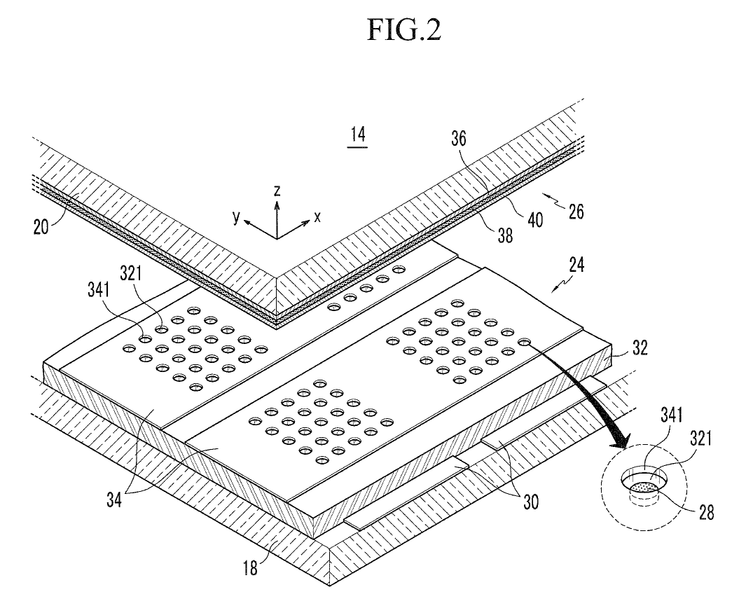

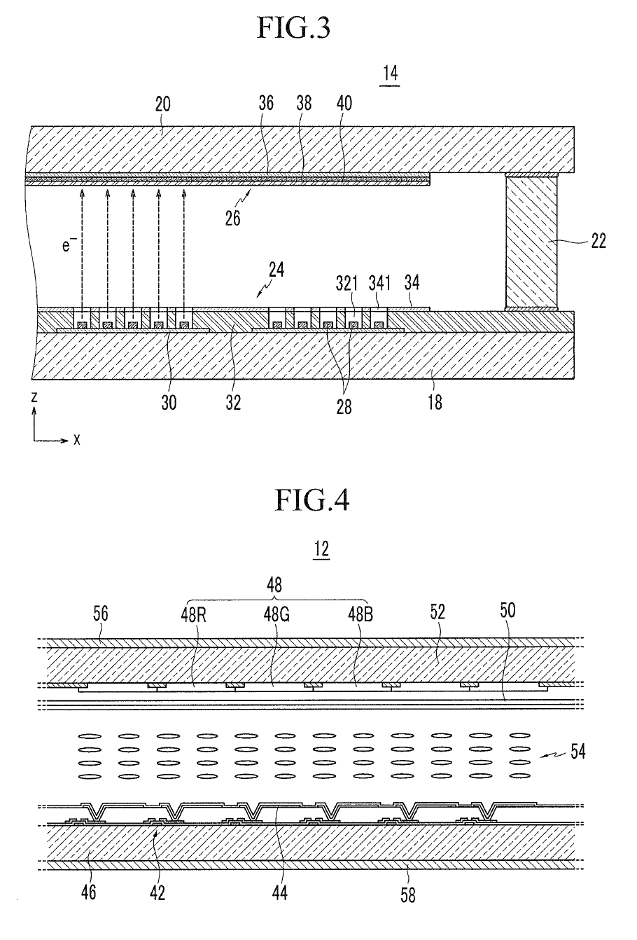

FIGS. 2 and 3 are respectively a partially cut perspective schematic and a partial cross-sectional schematic of the backlight device in FIG. 1.

With reference to FIGS. 2 and 3, the backlight device 14 according to an embodiment includes the vacuum panel composed of first and second substrates 18 and 20 disposed to face each other, and a sealing member 22 disposed on edge portions (or edges) of the first and second substrates 18 and 20 and for attaching the substrates 18 and 20 together. The interior of the vacuum panel is maintained at a vacuum degree of about 10⁻⁶ Torr.

An electron emission unit 24 including electron emission elements is positioned on an active area of an inner surface of the first substrate 18 (or on an active area of a surface of the first substrate 18 facing the second substrate 20), and a light emission unit 26 for emitting visible light is positioned on an active area of an inner surface of the second substrate 20 (or on an active area of a surface of the second substrate 20 facing the first substrate 18). The second substrate 20 with the light emission unit 26 positioned thereon may be a front substrate of the backlight device 14.

The electron emission unit 24 includes electron emission regions 28 using a cold cathode electron source and driving electrodes that control an amount of a discharged current of the electron emission regions 28. The driving electrodes include cathode electrodes 30 formed in a stripe pattern extending along a first direction (y-axis direction in FIG. 2) of the first substrate 18, and gate electrodes 34 formed in a stripe pattern extending along a second direction (x-axis direction in FIG. 2) that crosses the first direction of the cathode electrodes 30 at an upper portion of the cathode electrodes 30 with an insulation layer 32 interposed therebetween.

Openings 341 and 321 are formed at the gate electrodes 34 and at the insulation layer 32 at crossing points (e.g., every crossing point) of the cathode electrodes 30 and the gate electrodes 34, thereby exposing a portion of the surface of the cathode electrodes 30. The electron emission regions 28 are positioned on the cathode electrodes 30 at (or near) an inner side of the insulation layer openings 321.

The electron emission regions 28 include materials such as carbon-based materials or nanometer-sized materials that emit electrons when an electric field is applied under a vacuum state. The electron emission regions 28 may be composed of carbon nanotubes, graphite, graphite nanofibers, diamond, diamond-like carbon, fullerene C₆₀, and/or silicon nanowire.

In the above configuration, a single cathode electrode 30, a single gate electrode 34, and the electron emission regions 28 positioned at the crossing points of the cathode electrode 30 and the gate electrode 34 constitute a single electron emission element. The single electron emission element may be positioned at a single pixel area of the backlight device 14, or two or more electron emission elements may be positioned at a single pixel area of the backlight device 14.

In the above description, the electron emission elements are field emission array (FEA) type of elements, but the electron emission elements may alternatively be formed as surface conduction emission (SCE) type of electron emission elements, metal-insulator-metal (MIM) type of electron emission elements, and/or metal-insulator-semiconductor (MIS) type of electron emission elements.

The light emission unit 26 includes an anode electrode 36, a phosphor layer 38 positioned on one surface of the anode electrode 36, and a reflective layer 40 that covers the phosphor layer 38.

The anode electrode 36 is made of a transparent conductive material such as indium tin oxide (ITO) to allow visible light emitted from the phosphor layer 38 to be transmitted therethrough. The anode electrode 36, which is an accelerating electrode that attracts electron beams, receives a positive DC voltage (anode voltage) of about 10 kV to maintain the phosphor layer 38 in a high potential state.

The phosphor layer 38 may be formed as white phosphors in which red phosphor, green phosphor, and blue phosphor are mixed.

For example, the red phosphor may be Y₂O₃:Eu, Y₂O₂S:Eu, and/or SrTiO₃:Pr; the green phosphor may be Y₂SiO₅:Tb, Gd₂O₂S:Tb, ZnS:(Cu, Al), ZnSiO₄:Mn, and/or Zn(Ga, Al)₂O₄:Mn; and the blue phosphor may be ZnS:(Ag, Al), Y₂SiO₅:Ce, and/or BaMgAl₁₀O₁₇:Eu. The phosphor layer 38 may contain from about 15 wt % to about 30 wt % (or from 15 wt % to 30 wt %) of red phosphor, from about 30 wt % to about 60 wt % (or from 30 wt % to 60 wt %) of green phosphor, and from about 24 wt % to about 45 wt % (or from 24 wt % to 45 wt %) of blue phosphor.

The phosphor layer 38 may be positioned over an entire active area of the second substrate 20, or may be separately positioned at each pixel area. FIGS. 2 and 3 show the case where the phosphor layer 38 is positioned over the entire active area of the second substrate 20.

The reflective layer 40 may be formed of an aluminum layer with a thickness of thousands of angstroms (A), and includes fine holes for allowing electron beams to pass therethrough. The reflective layer 40 serves to increase luminance of the backlight device 14 by reflecting visible light, which is a portion of light that has been emitted from the phosphor layer 38 to the first substrate 18, back to the second substrate 20. Also, the anode electrode 36 may be omitted, and instead, the reflective layer 40 may serve as an anode electrode upon receiving an anode voltage.

Spacers may be positioned between the first and second substrates 18 and 20 in order to support a compressive force applied to the vacuum panel formed therefrom and to maintain a uniform space between the substrates 18 and 20.

The backlight device 14 having such a structure as described above is driven by applying a scan driving voltage to either the cathode electrodes 30 or the gate electrodes 34, a data driving voltage to the other electrodes (not being applied with the scan voltage), and an anode voltage of more than thousands of volts to the anode electrode 36.

Then, electric fields are formed around the electron emission regions 28 at pixels where a voltage difference between the cathode electrodes 30 and the gate electrodes 34 is greater than a threshold value, and electrons are emitted therefrom. The emitted electrons are attracted by the anode voltage applied to the anode electrode 36 to collide with a corresponding region of the phosphor layer 38 such that light is emitted at the corresponding region. The luminance of the phosphor layer 38 of each pixel corresponds to an emitted amount of electrons of the corresponding pixels.

FIG. 4 is a partial cross-sectional schematic of a display panel in FIG. 1.

With reference to FIG. 4, the display panel 12 includes a lower substrate 46 on which thin film transistors (TFTs) 42 and pixel electrodes 44 are formed, an upper substrate 52 on which color filters 48 and a common electrode 50 are formed, and a liquid crystal layer 54 injected between the upper and lower substrates 52 and 46. Polarizing plates 56 and 58 are attached on an upper surface of the upper substrate 52 and a lower surface of the lower substrate 46, respectively, in order to polarize light that passes through the display panel 12.

A pixel electrode 44 is positioned for each sub-pixel, and driving of the pixel electrodes is controlled by the TFTs 42. The pixel electrodes 44 and the common electrode 50 are made of a transparent conductive material. The color filters 48 include a red filter 48R, a green filter 48G, and a blue filter 48B, which are respectively positioned at each sub-pixel.

When the TFT 42 of a particular sub-pixel is turned on, an electric field is formed between the pixel electrode 44 and the common electrode 50, an arrangement angle of liquid crystal molecules changes by the electric field, and light transmittance varies according to the changed arrangement angle. The luminance of each pixel and emission colors in the display panel 12 can be controlled through such a process.

With reference to FIG. 1, a gate circuit board assembly 60 is for transmitting a gate drive signal to a gate electrode of each TFT, and a data circuit board assembly 62 is for transmitting a data drive signal to a source electrode of each TFT.

The backlight device 14 includes a smaller number of pixels than does the display panel 12, so that a single pixel of the backlight device 14 corresponds to two or more pixels of the display panel 12. Each pixel of the backlight device 14 may emit light to correspond to the highest gray level among gray levels of a corresponding set of pixels of the display panel 12, and may represent a gray scale of 2 to 8 bits.

For convenience, the pixels of the display panel 12 are called first pixels, the pixels of the backlight device 14 are called second pixels, and two or more of the first pixels corresponding to an individual one of the second pixels are called a first pixel group.

A driving process of the backlight device 14 may include: \textcircled{1} detecting, by a signal controller that controls the display panel 12, the highest gray level of the first pixels of the first pixel group, \textcircled{2} calculating a gray level required for emitting the second pixels according to the detected gray level and converting the same into digital data, \textcircled{3} generating a drive signal of the backlight device 14 by using the digital data, and \textcircled{4} applying the generated drive signal to the driving electrodes of the backlight device 14.

The drive signal of the backlight device 14 includes a scan drive signal and a data drive signal. A scan circuit board assembly and a data circuit board assembly for driving the backlight device 14 may be positioned on a back side of the backlight device 14.

In FIG. 1, a first connector 64 is for connecting the cathode electrodes 30 and the data circuit board assembly, and a second connector 66 is for connecting the gate electrodes 34 and the scan circuit board assembly. Also, a third connector 68 is for applying the anode voltage to the anode electrode 36.

When an image is displayed by a corresponding first pixel group, the second pixel of the backlight device 14 is synchronized with the first pixel group and emits light with a certain gray level. Namely, the backlight device 14 provides light of a relatively high luminance to a bright region of a screen image displayed on the display panel 12, and provides light of a relatively low luminance to a dark region thereof. Accordingly, the LCD 100 according to an embodiment can have an improved contrast ratio of screen images and obtain sharp picture quality.

FIG. 5 is a graph showing a spectrum of white light emitting from the backlight device in FIG. 1.

With reference to FIG. 5, the spectrum of white light emitted by the backlight device 14 includes a blue peak with a wavelength of about 450 nm, a green peak with a wavelength of about 530 nm, and a red peak with a wavelength of about 610 nm. The blue light and the green light have gentle (broad) peak characteristics, while the red light exhibits narrow peak characteristics. The peak intensity ratio of the blue light, the green light, and the red light may be about 1.5:1:2.

Table 1 shows the emission characteristics of white light emitted from the backlight device 14.

TABLE 1

| Phosphor | red | green | blue | white |
|---|---|---|---|---|
| Color | 0.6553 | 0.2877 | 0.1416 | 0.2622 |
| coordinate (x) | | | | |
| Color | 0.3424 | 0.6713 | 0.0775 | 0.3139 |
| coordinate (y) | | | | |

| | |
|---|---|
| Color | 84.19% |
| reproduction | |
| rate | |
| Color | 10383 K |
| temperature | |

The color filters 48 of the LCD 100 according to an embodiment have the following suitable (or configured) characteristics, under the condition that the color reproduction rates of red light, green light, and blue light that appear after white light of the backlight device 14 passes through the color filters 48 are set to be 72% or higher as a limit value.

Among the three color filters, the red filter 48R will be described in more detail first as follows.

In the exemplary embodiment of the present invention, the red filter 48R satisfies the conditions that a wavelength position corresponding to a half of the peak intensity is within the range from about 570 nm to about 622 nm (or from 570 nm to 622 nm).

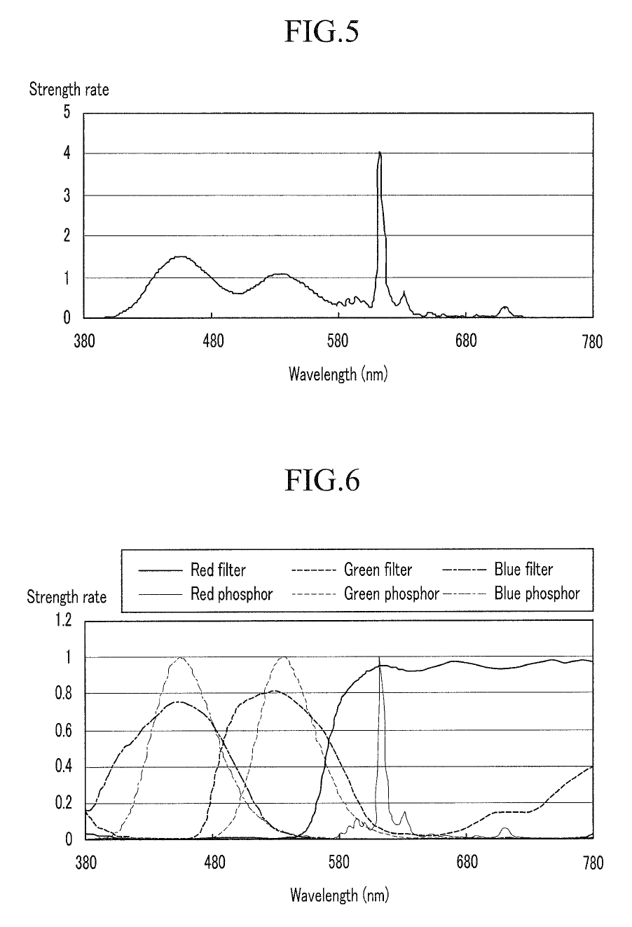

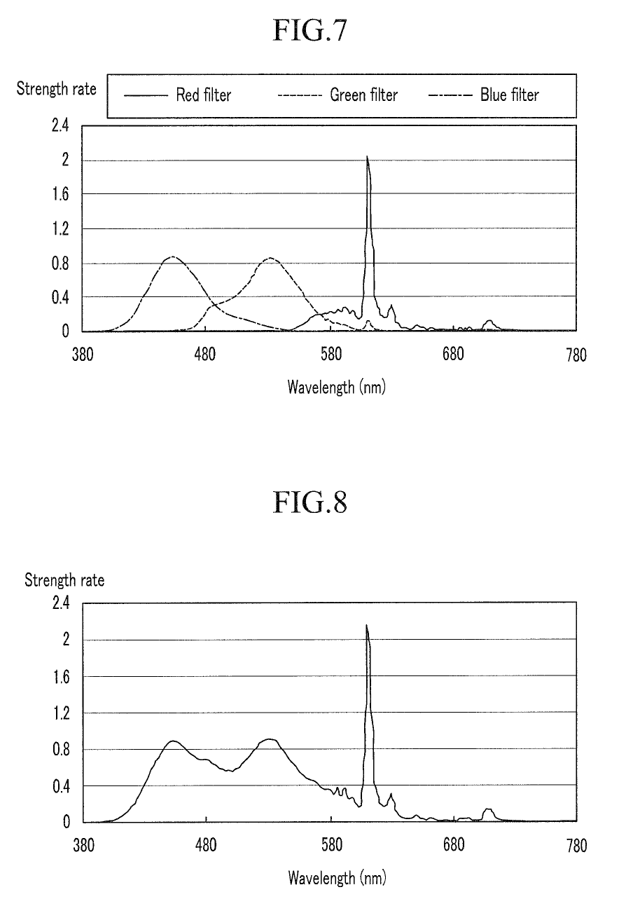

FIG. 6 is a graph showing a transmission spectrum of the color filter including the red filter of which a wavelength position that corresponds to the half of the peak intensity is at about 570 nm (or at 570 nm), and emission spectrums of the red, green, and blue phosphors constituting the phosphor layer of the backlight device 14. FIG. 7 is a graph showing emission spectrums of red, green, and blue light that has passed through color filters having transmission characteristics of FIG. 6, and FIG. 8 is a graph showing an emission spectrum of white light that has passed through the color filters having the transmission characteristics of FIG. 6.

Table 2 shows emission characteristics of the LCD 100 having the red filter 48R of which a wavelength position that corresponds to the half of the peak intensity is at 570 nm.

TABLE 2

| Phosphor | red | green | blue | white |
|---|---|---|---|---|
| Color | 0.6021 | 0.2426 | 0.1412 | 0.2797 |
| coordinate (x) | | | | |
| Color | 0.3812 | 0.6408 | 0.0757 | 0.3363 |
| coordinate (y) | | | | |

| | |
|---|---|
| Color | 72.53% |
| reproduction | |
| rate | |
| Color | 8343 K |
| temperature | |

In one embodiment, if the wavelength position corresponding to the half of the peak intensity in the red filter 48R is less than 570 nm, the red filter 48R would allow light corresponding to a wavelength band of green phosphor to transmit therethrough. Then, color coordinate characteristics of the red color would be degraded and the color reproduction rate would drop to below 72%. As noted in Table 2, when the wavelength position corresponding to the half of the peak intensity in the red filter 48R is at 570 nm, a color reproduction rate of 72.53% can be obtained.

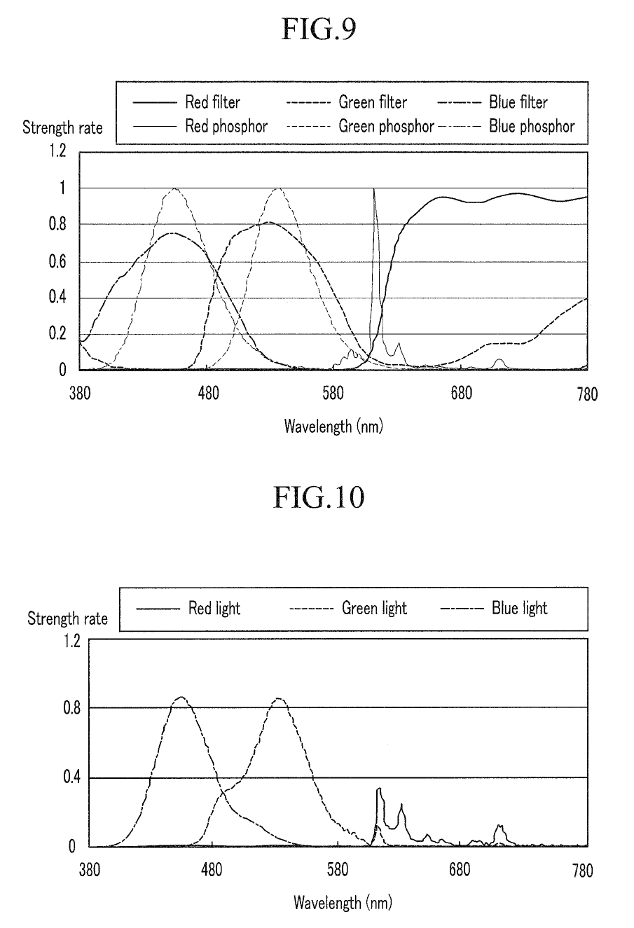

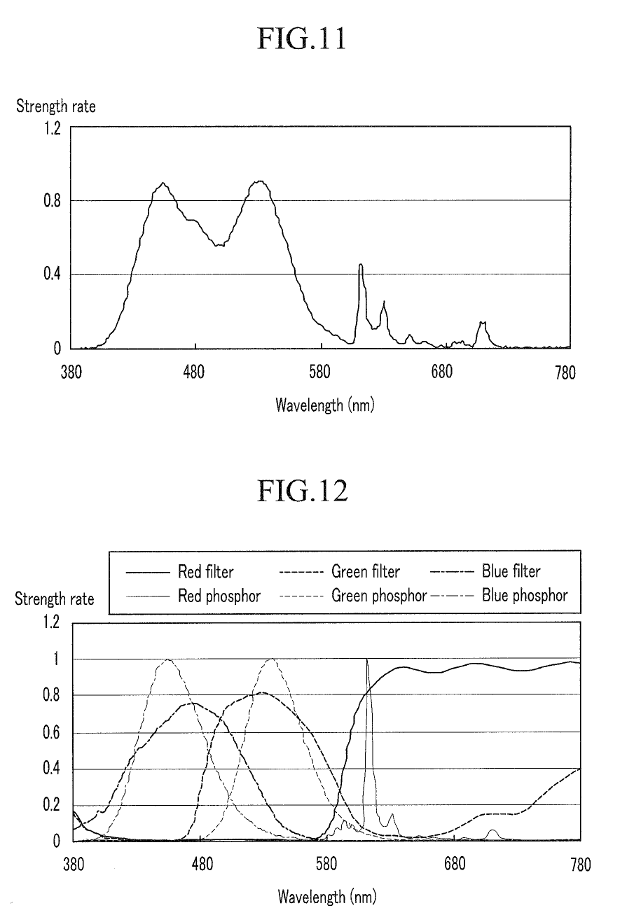

FIG. 9 is a graph showing a transmission spectrum of a color filter including a red filter of which a wavelength position that corresponds to a half of a peak intensity is at about 622 nm (or at 622 nm), and emission spectrums of red, green, and blue phosphors constituting the phosphor layer of the backlight device 14. FIG. 10 is a graph showing emission spectrums of red, green, and blue light that has passed through the color filters having the transmission characteristics of FIG. 9, and FIG. 11 is a graph showing an emission spectrum of white light that has passed through the color filters having the transmission characteristics of FIG. 9.

Table 3 shows the emission characteristics of the LCD 100 having the red filter 48R of which a wavelength position that corresponds to the half of the peak intensity is at 622 nm.

TABLE 3

| Phosphor | red | green | blue | white |
|---|---|---|---|---|
| Color | 0.5893 | 0.2426 | 0.1412 | 0.2072 |
| coordinate | | | | |
| (x) | | | | |
| Color | 0.2973 | 0.6408 | 0.0757 | 0.3218 |
| coordinate | | | | |
| (y) | | | | |

| | |
|---|---|
| Color | 72.93% |
| reproduction | |
| rate | |
| Color | 15152 K |
| temperature | |

In one embodiment, if the wavelength position corresponding to the half of the peak intensity in the red filter 48R exceeds 622 nm, the red filter 48R would have an inclined wavelength longer than a wavelength band of the red phosphor, resulting in a main peak of the red phosphor being reduced and a minor peak being amplified. Then, the color coordinate characteristics of the red color would be degraded and the color reproduction rate would drop to below 72%. As noted in Table 3, when the wavelength position corresponding to the half of the peak intensity in the red filter 48R is at 622 nm, a color reproduction rate of 72.93% can be obtained.

As noted in Table 2 and Table 3, when the conditions that the wavelength corresponding to the half of the peak intensity in the red filter 48R is within the range of 570 nm to 622 nm are met, a color reproduction rate of 72% or higher can be obtained.

The blue filter 48B will now be described in more detail.

In the exemplary embodiment of the present invention, the blue filter 48B satisfies the conditions that the wavelength position corresponding to the half of the peak intensity is at about 520 nm or less (or at 520 nm).

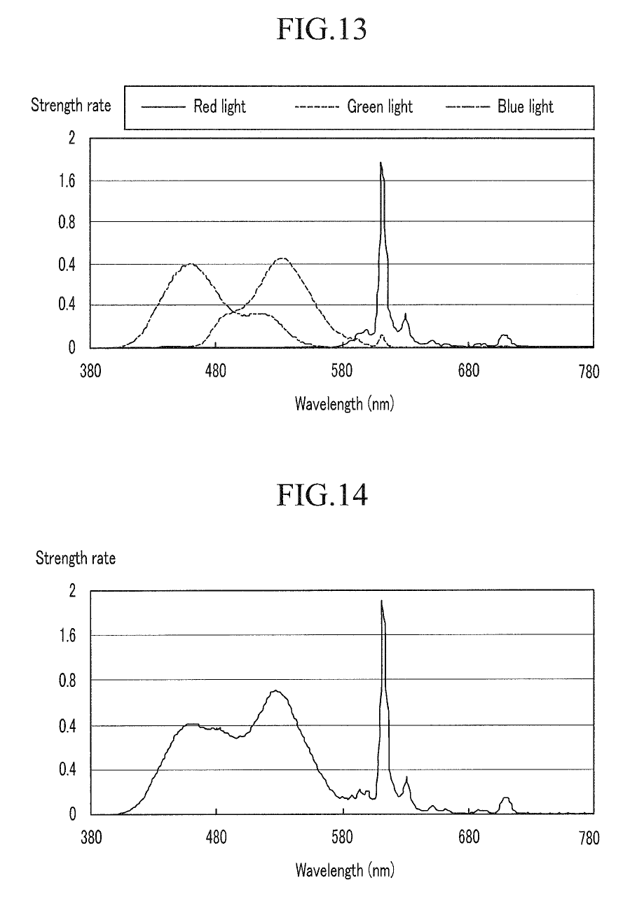

FIG. 12 is a graph showing a transmission spectrum of a color filter including a blue filter of which a wavelength position that corresponds to a half of a peak intensity is at 520 nm, and emission spectrums of red, green, and blue phosphors constituting the phosphor layer of the backlight device 14. FIG. 13 is a graph showing emission spectrums of red, green, and blue light that has passed through the color filter having the transmission characteristics of FIG. 12, and FIG. 14 is a graph showing an emission spectrum of white light that has passed through the color filter having the transmission characteristics of FIG. 12.

Table 4 shows the emission characteristics of the LCD 100 having the blue filter 48B of which a wavelength position that corresponds to the half of the peak intensity is at 520 nm.

TABLE 4

| Phosphor | red | green | blue | white |
|---|---|---|---|---|
| Color | 0.6411 | 0.2426 | 0.1369 | 0.2537 |
| coordinate | | | | |
| (x) | | | | |
| Color | 0.3285 | 0.6408 | 0.1509 | 0.3572 |
| coordinate | | | | |
| (y) | | | | |

| | |
|---|---|
| Color | 72.13% |
| reproduction | |
| rate | |
| Color | 9429 K |
| temperature | |

In one embodiment, if the wavelength position corresponding to the half of the peak intensity in the blue filter 48B exceeds 520 nm, the blue filter 48B would allow light corresponding to a wavelength band of the green phosphor to transmit therethrough. Then, the color coordinate characteristics of the blue color would be degraded and the color reproduction rate would drop to below 72%. As noted in Table 4, when the wavelength position corresponding to the half of the peak intensity in the blue filter 48B is at 520 nm, a color reproduction rate of 72.13% can be obtained.

The green filter 48G will now be described in more detail.

In the exemplary embodiment of the present invention, the green filter 48G satisfies the conditions that a width (full width at half maximum (FWHM)) of a wavelength position corresponding to the half of a peak intensity is within the range from about 60 nm to about 115 nm (or from 60 nm to 115 nm).

As the FWHM becomes reduced, the green filter 48B exhibits a color reproduction rate of 72% or greater within a wider transmission band movement range.

Experimentation results show that the green filter 48G obtained a color reproduction rate of 72% or higher within the transmission band movement range of 49 nm or less when the FWHM of the green filter 48G was 60 nm, and within the transmission band movement range of 44 nm or less when the FWHM was 80 nm. In addition, the green filter 48G obtained a color reproduction rate of 72% or higher within the transmission band movement range of 36 nm or less when the FWHM of the green filter 48G was 100 nm, and within the transmission band movement range of 7 nm or less when the FWHM was 115 nm.

In one embodiment, if the FWHM is 116 nm, the green filter 48G would obtain a color reproduction rate of less than 72%, and if the FWHM is less than 60 nm, the luminance of the green light would be significantly degraded.

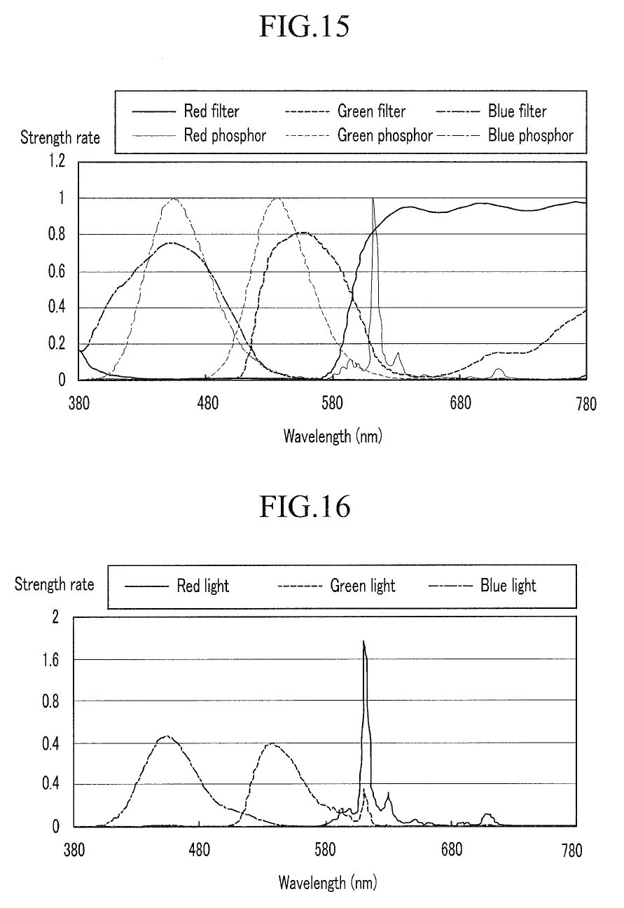

FIG. 15 is a graph showing a transmission spectrum of the color filter including the green filter having the FWHM of about 60 nm (or 60 nm) and a peak wavelength of about 556 nm, and emission spectrums of the red, green, and blue phosphors constituting the phosphor layer of the backlight device. FIG. 16 is a graph showing emission spectrums of red, green, and blue light that has passed through the color filters having the transmission characteristics of FIG. 15.

The LCD 100 having the green filter 48G exhibits a color reproduction rate of 73%. If the transmission spectrum of the green filter 48G moves to a wavelength longer than that shown in FIG. 15, the color reproduction rate would drop to below 72%. Namely, the transmission spectrum of the green filter 48G as shown in FIG. 15 shows a limit of the red color movement.

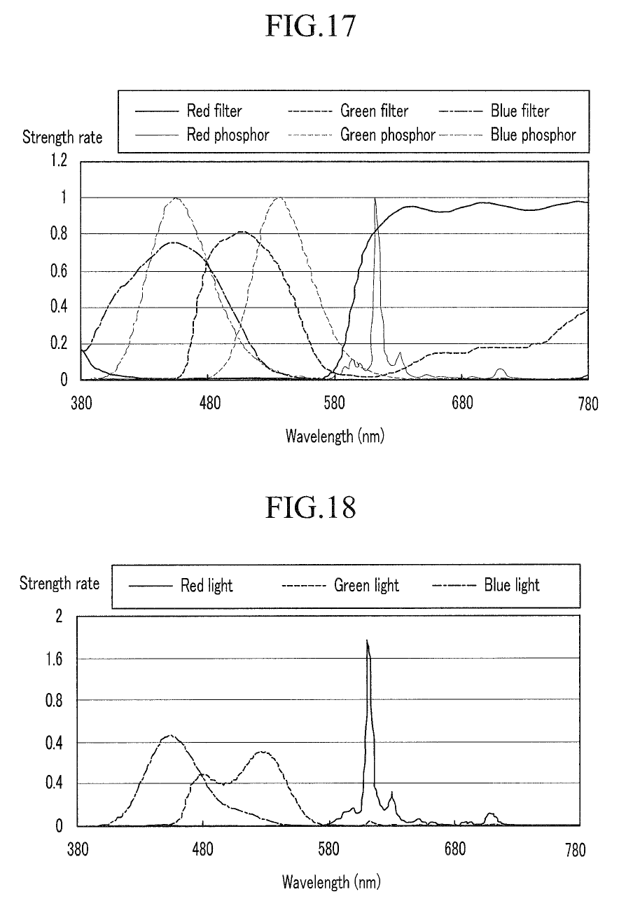

FIG. 17 is a graph showing a transmission spectrum of a color filter including a green filter having the FWHM of about 60 nm (or of 60 nm) and a peak wavelength of about 507 nm, and emission spectrums of the red, green, and blue phosphors constituting the phosphor layer of the backlight device. FIG. 18 is a graph showing emission spectrums of red, green, and blue light that has passed through the color filters having the transmission characteristics of FIG. 17.

The LCD 100 having the green filter 48G exhibits a color reproduction rate of 73.52%. If the transmission spectrum of the green filter 48G moves to a wavelength band shorter than that shown in FIG. 17, the color reproduction rate would drop to below 72%. Namely, the transmission spectrum of the green filter as shown in FIG. 17 shows a limit of the blue color movement.

As described above, in one embodiment, when the FWHM is 60 nm, the green filter 48G obtains a color reproduction rate of 72% or greater with the peak wavelength within the range of 507 nm to 556 nm (within the maximum transmission band movement range of 49 nm).

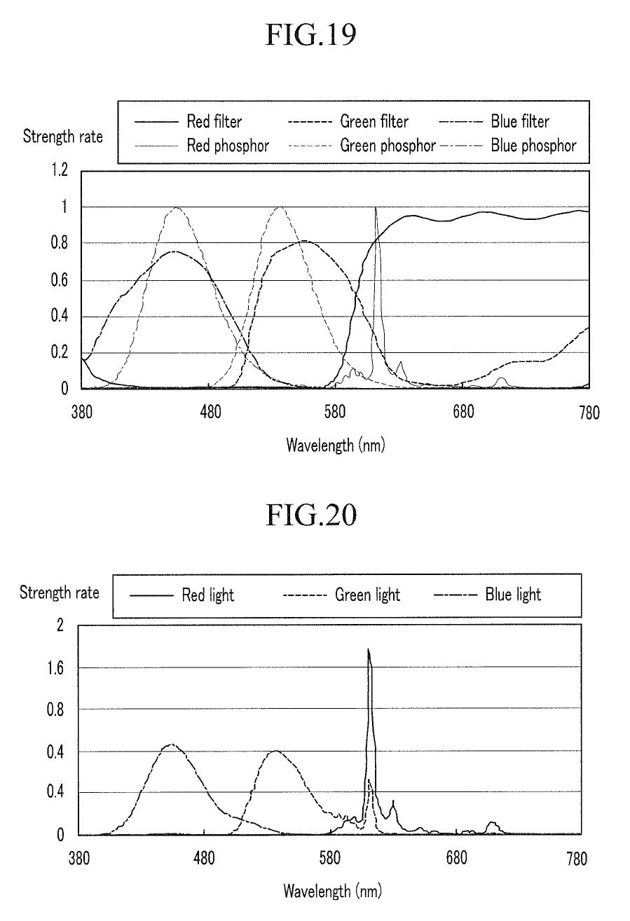

FIG. 19 is a graph showing a transmission spectrum of a color filter including a green filter having the FWHM of about 80 nm (or of 80 nm) and a peak wavelength of about 556 nm, and emission spectrums of the red, green, and blue phosphors constituting the phosphor layer of the backlight device. FIG. 20 is a graph showing emission spectrums of red, green, and blue light that has passed through the color filters having the transmission characteristics of FIG. 19.

The LCD 100 having the green filter 48G exhibits a color reproduction rate of 72.12%. If the transmission spectrum of the green filter 48G moves to a wavelength band longer than that shown in FIG. 19, the color reproduction rate would drop to below 72%. Namely, the transmission spectrum of the green filter 48G as shown in FIG. 19 shows a limit of the red color movement.

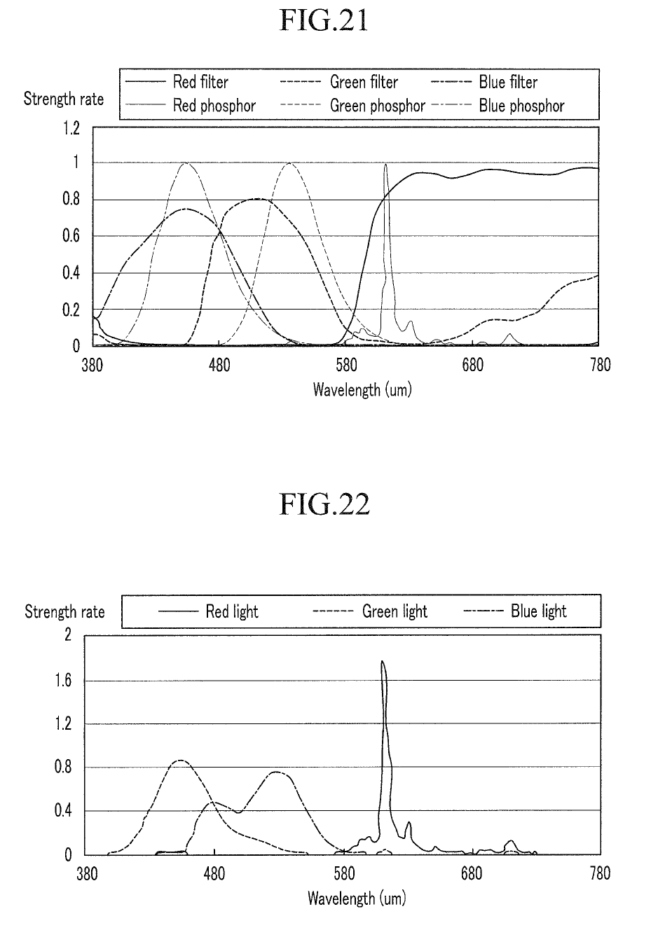

FIG. 21 is a graph showing a transmission spectrum of a color filter including a green filter having the FWHM of about 80 nm (or of 80 nm) and a peak wavelength of about 512 nm, and emission spectrums of the red, green, and blue phosphors constituting the phosphor layer of the backlight device. FIG. 22 is a graph showing emission spectrums of red, green, and blue light that has passed through the color filters having the transmission characteristics of FIG. 21.

The LCD 100 having the green filter 48G exhibits a color reproduction rate of 73.20%. If the transmission spectrum of the green filter 48G moves to a wavelength band shorter than that shown in FIG. 21, the color reproduction rate would drop to below 72%. Namely, the transmission spectrum of the green filter 48G as shown in FIG. 21 shows a limit of the blue color movement.

As described above, when the FWHM is 80 nm, the green filter 48G obtains a color reproduction rate of 72% or greater with the peak wavelength within the range of 512 nm to 556 nm (within the maximum transmission band movement range of 44 nm).

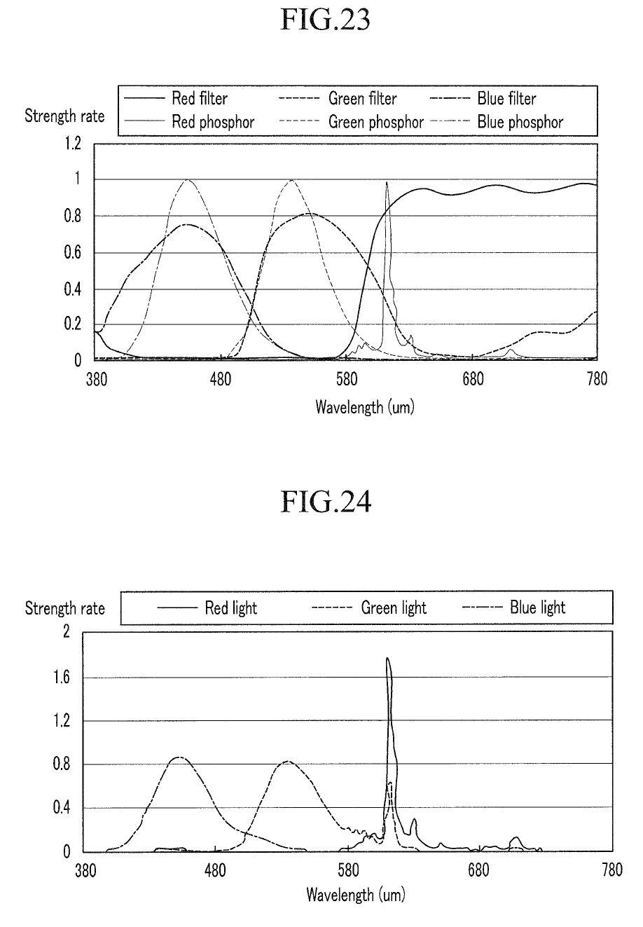

FIG. 23 is a graph showing a transmission spectrum of a color filter including a green filter having the FWHM of about 100 nm (or of 100 nm) and a peak wavelength is about 553 nm, and emission spectrums of the red, green, and blue phosphors constituting the phosphor layer of the backlight device. FIG. 24 is a graph showing emission spectrums of red, green, and blue light which have passed through the color filters having the transmission characteristics of FIG. 23.

The LCD 100 having the green filter 48G exhibits a color reproduction rate of 72.22%. In one embodiment, if the transmission spectrum of the green filter 48G moves to a wavelength band longer than that shown in FIG. 23, the color reproduction rate would drop to below 72%. Namely, the transmission spectrum of the green filter 48G as shown in FIG. 23 shows a limit of the red color movement.

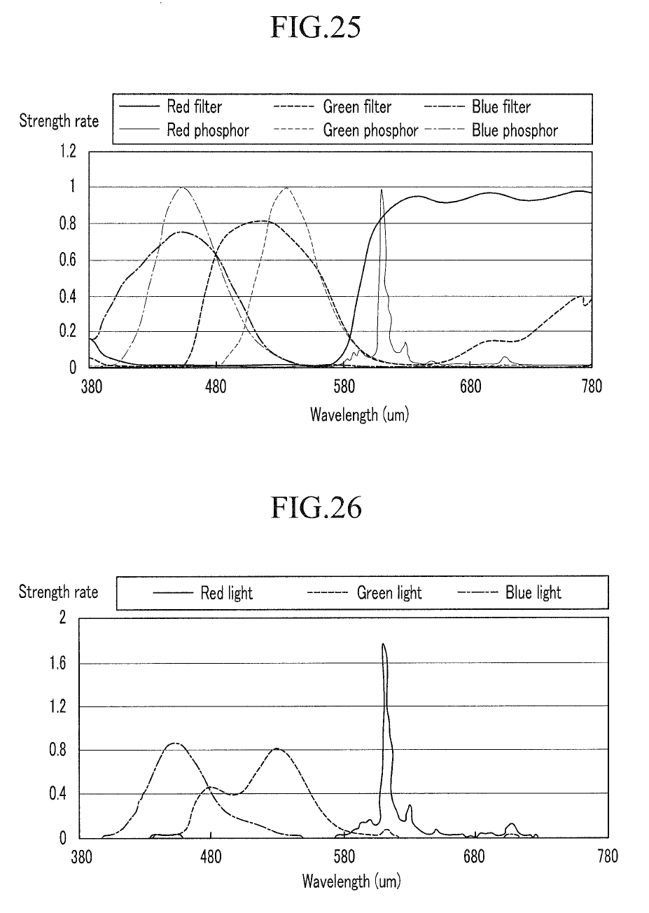

FIG. 25 is a graph showing a transmission spectrum of a color filter including a green filter the FWHM of about 100 nm (or of 100 nm) and a peak wavelength of about 517 nm, and emission spectrums of the red, green, and blue phosphors constituting the phosphor layer of the backlight device. FIG. 26 is a graph showing emission spectrums of red, green, and blue light that has passed through the color filters having the transmission characteristics of FIG. 25.

The LCD 100 having the green filter 48G exhibits a color reproduction rate of 72.97%. If the transmission spectrum of the green filter 48G moves to a wavelength band shorter than that shown in FIG. 25, the color reproduction rate would drop to below 72%. Namely, the transmission spectrum of the green filter 48G as shown in FIG. 25 shows a limit of the blue color movement.

As described above, when the FWHM is 100 nm, the green filter 48G obtains a color reproduction rate of 72% or greater with the peak wavelength within the range of 517 nm to 553 nm (within the maximum transmission band movement range of 36 nm).

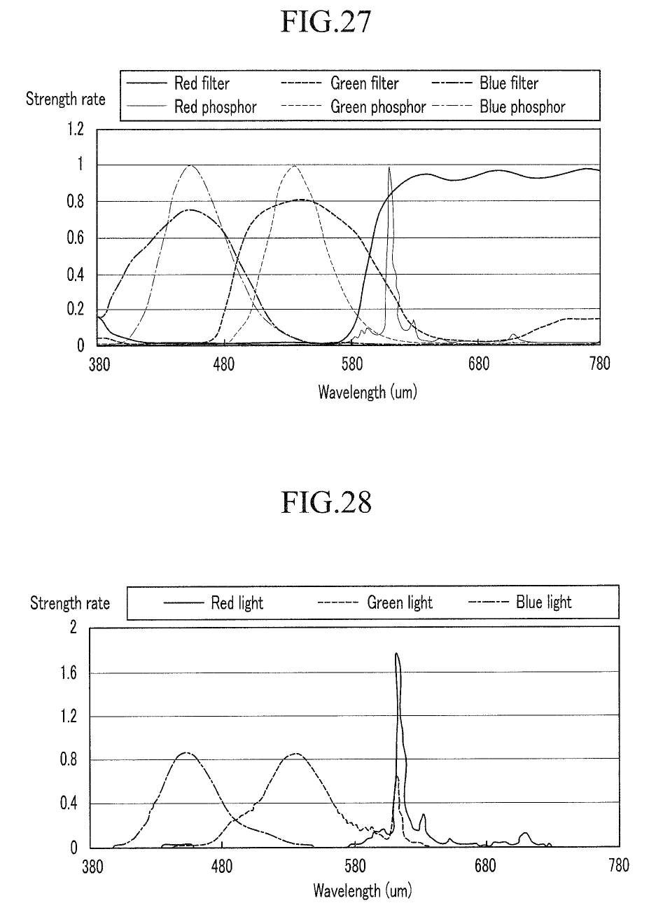

FIG. 27 is a graph showing a transmission spectrum of a color filter including a green filter having the FWHM of about 115 nm (or of 115 nm) and a peak wavelength of about 542 nm, and emission spectrums of the red, green, and blue phosphors constituting the phosphor layer of the backlight device. FIG. 28 is a graph showing emission spectrums of red, green, and blue light that has passed through the color filters having the transmission characteristics of FIG. 27.

The LCD 100 having the green filter 48G exhibits a color reproduction rate of 72.06%. If the transmission spectrum of the green filter 48G moves to a wavelength band longer than that shown in FIG. 27, the color reproduction rate would drop to below 72%. Namely, the transmission spectrum of the green filter 48G as shown in FIG. 27 shows a limit of the red color movement.

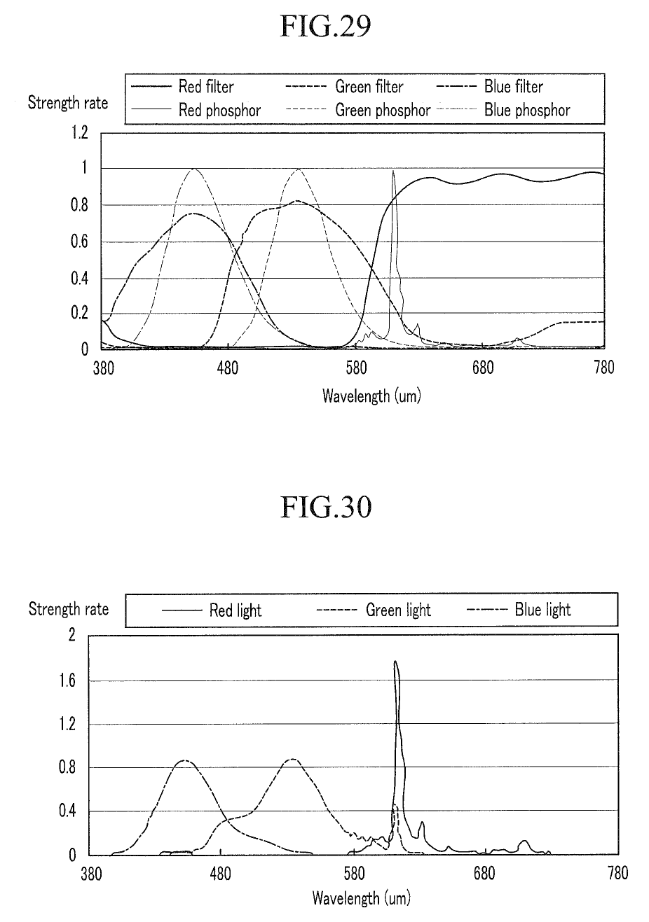

FIG. 29 is a graph showing a transmission spectrum of a color filter including a green filter having the FWHM of about 115 nm (or of 115 nm) and a peak wavelength of about 535 nm, and emission spectrums of the red, green, and blue phosphors constituting the phosphor layer of the backlight device. FIG. 30 is a graph showing emission spectrums of red, green, and blue light that has passed through the color filters having the transmission characteristics of FIG. 29.

The LCD having the green filter 48G exhibits a color reproduction rate of 72.10%. If the transmission spectrum of the green filter 48G moves to a wavelength band shorter than that shown in FIG. 29, the color reproduction rate would drop to below 72%. Namely, the transmission spectrum of the green filter 48G as shown in FIG. 29 shows a limit of the blue color movement.

As described above, when the FWHM is 115 nm, the green filter 48G obtains a color reproduction rate of 72% or greater with the peak wavelength within the range of 535 nm to 542 nm (within the maximum transmission band movement range of 7 nm).

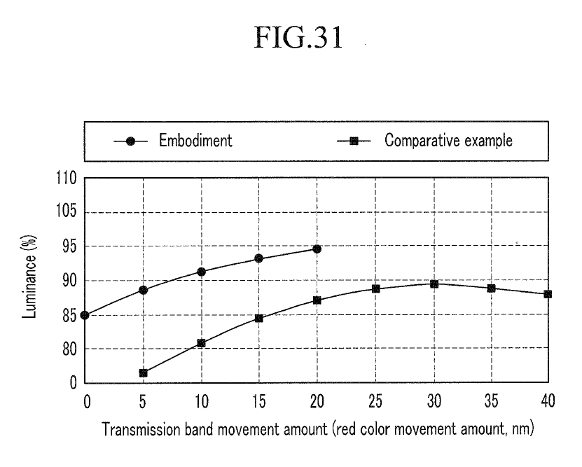

FIG. 31 is a graph showing results of luminance experimentation of an exemplary embodiment of the present invention in which the FWHM of the green filter was about 78 nm (or 78 nm) and a comparative example in which the FWHM of the green filter was about 58 nm (or 58 nm). In FIG. 31, the horizontal axis indicates transmission band movement amount (red color movement amount) that is set based on the wavelength of 515 nm. The vertical axis indicates a relative luminance value over maximum luminance when the maximum luminance is set as 100%.

With reference to FIG. 31, in the embodiment in which the FWHM of the green filter is 78 nm, it can be noted that as the red color movement amount increases, the luminance is increased. Meanwhile, in the comparative example in which the FWHM of the green filter is 58 nm, as the red color movement amount increases, the luminance is increased but is lower overall than that in the embodiment of the present invention. Particularly, in the comparative example, when the red color movement amount is 15 nm or lower, notably, luminance lower than 85% is implemented.

As described above, in an embodiment of the LCD 100, because the characteristics of the color filters 48, namely, the FWHM and the wavelength position corresponding to the half of the peak intensity, are configured by the red, green, and blue filters 48R, 48G, and 48B according to the optical characteristics of the backlight device 14, a color reproduction rate of 72% or higher can be obtained and degradation of luminance can be reduced (or minimized).

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A liquid crystal display comprising:
a display panel having color filters comprising a red filter, a green filter, and a blue filter; and
a backlight device positioned at a rear side of the display panel and comprising a vacuum panel with a cold cathode electron source and a phosphor layer adapted to be excited by electrons emitted from the cold cathode electron source to emit visible light,
wherein a wavelength position corresponding to a half of a peak intensity of a transmission spectrum of the red filter is at from about 570 nm to about 622 nm.

2. The liquid crystal display of claim 1, wherein the phosphor layer comprises red phosphor, green phosphor, and blue phosphor, wherein the red phosphor is selected from the group consisting of Y₂O₃:Eu, Y₂O₂S:Eu, SrTiO₃:Pr, and combinations thereof, wherein the green phosphor is selected from the group consisting of Y₂SiO₅:Tb, Gd₂O₂S:Tb, ZnS:(Cu, Al), ZnSiO₄:Mn, Zn(Ga, Al)₂O₄:Mn, and combinations thereof, and wherein the blue phosphor is selected from the group consisting of ZnS:(Ag, Al), Y₂SiO₅:Ce, BaMgAl₁₀O₁₇:Eu, and combinations thereof.

3. The liquid crystal display of claim 1, wherein x and y color coordinates of white light emitted from the phosphor layer are 0.2622 and 0.3139, respectively.

4. The liquid crystal display of claim 1, wherein the white light emitted from the phosphor layer exhibits a blue peak wavelength at about 450 nm, a green peak wavelength at about 530 nm, and a red peak wavelength at about 610 nm.

5. The liquid crystal display of claim 4, wherein the peak intensity ratio of blue light, green light, and red light of the white light emitted from the phosphor layer is 1.5:1:2.

6. The liquid crystal display of claim 1, wherein the display panel comprises a plurality of first pixels, wherein the backlight includes a plurality of second pixels smaller in number than the first pixels, and wherein each of the second pixels is adapted to independently emit light with an intensity in accordance with gray levels of a corresponding set of the first pixels.

7. A liquid crystal display comprising:
a display panel having color filters comprising a red filter, a green filter, and a blue filter; and
a backlight device positioned at a rear side of the display panel and comprising a vacuum panel with a cold cathode electron source and a phosphor layer adapted to be excited by electrons emitted from the cold cathode electron source to emit visible light,
wherein a wavelength position corresponding to a half of a peak intensity of a transmission spectrum of the blue filter is not greater than 520 nm.

8. The liquid crystal display of claim 7, wherein the phosphor layer comprises red phosphor, green phosphor, and blue phosphor, wherein the red phosphor is selected from the group consisting of Y₂O₃:Eu, Y₂O₂S:Eu, SrTiO₃:Pr, and combinations thereof, wherein the green phosphor is selected from the group consisting of Y₂SiO₅:Tb, Gd₂O₂S:Tb, ZnS:(Cu, Al), ZnSiO₄:Mn, Zn(Ga, Al)₂O₄:Mn, and combinations thereof, and wherein the blue phosphor is selected from the group consisting of ZnS:(Ag, Al), Y₂SiO₅:Ce, BaMgAl₁₀O₁₇:Eu, and combinations thereof.

9. The liquid crystal display of claim 7, wherein x and y color coordinates of white light emitted from the phosphor layer are 0.2622 and 0.3139, respectively.

10. The liquid crystal display of claim 7, wherein the white light emitted from the phosphor layer exhibits a blue peak wavelength at about 450 nm, a green peak wavelength at about 530 nm, and a red peak wavelength at about 610 nm.

11. The liquid crystal display of claim 10, wherein the peak intensity ratio of blue light, green light, and red light of the white light emitted from the phosphor layer is 1.5:1:2.

12. The liquid crystal display of claim 7, wherein the display panel comprises a plurality of first pixels, wherein the backlight device comprises a plurality of second pixels smaller in number than the first pixels, and wherein the second pixels emit light with an intensity in accordance with gray levels of a corresponding set of the first pixels.

13. A liquid crystal display comprising:
a display panel having color filters comprising a red filter, a green filter, and a blue filter; and
a backlight device positioned at a rear side of the display panel and comprising a vacuum panel with a cold cathode electron source and a phosphor layer adapted to be excited by electrons emitted from the cold cathode electron source to emit visible light,
wherein a transmission spectrum of the green filter has a full width at half maximum (FWHM) ranging from about 60 nm to about 115 nm.

14. The liquid crystal display of claim 13, wherein the transmission spectrum of the green filter has the FWHM of about 60 nm and a peak wavelength ranging from about 507 nm to about 556 nm.

15. The liquid crystal display of claim 13, wherein the transmission spectrum of the green filter has the FWHM of about 80 nm and a peak wavelength ranging from about 512 nm to about 556 nm.

16. The liquid crystal display of claim 13, wherein the transmission spectrum of the green filter has the FWHM of about 100 nm and a peak wavelength ranging from about 517 nm to about 553 nm.

17. The liquid crystal display of claim 13, wherein the transmission spectrum of the green filter has the FWHM of about 115 nm and a peak wavelength ranging from about 535 nm to about 542 nm.

18. The liquid crystal display of claim 13, wherein the phosphor layer comprises red phosphor, green phosphor, and blue phosphor, wherein the red phosphor is selected from the group consisting of Y₂O₃:Eu, Y₂O₂S:Eu, SrTiO₃:Pr, and combinations thereof, wherein the green phosphor is selected from the group consisting of Y₂SiO₅:Tb, Gd₂O₂S:Tb, ZnS:(Cu, Al), ZnSiO₄:Mn, Zn(Ga, Al)₂O₄:Mn, and combinations thereof, and wherein the blue phosphor is selected from the group consisting of ZnS:(Ag, Al), Y₂SiO₅:Ce, BaMgAl₁₀O₁₇:Eu, and combinations thereof.

19. The liquid crystal display of claim 13, wherein x and y color coordinates of white light emitted from the phosphor layer are 0.2622 and 0.3139, respectively.

20. The liquid crystal display of claim 13, wherein the white light emitted from the phosphor layer exhibits a blue peak wavelength at about 450 nm, a green peak wavelength at about 530 nm, and a red peak wavelength at about 610 nm.

21. The liquid crystal display of claim 20, wherein the peak intensity ratio of blue light, green light, and red light of the white light emitted from the phosphor layer is 1.5:1:2.

22. The liquid crystal display of claim 13, wherein the display panel comprises a plurality of first pixels, wherein the backlight device comprises a plurality of second pixels smaller in number than the first pixels, and wherein each of the second pixels is adapted to independently emit light with an intensity in accordance with gray levels of a corresponding set of the first pixels.
